(19) United States
(12) Patent Application Publication
(10) Pub. No.: US 2026/0210613 A1
(43) Pub. Date: Jul. 23, 2026

(54) ICE MAKER, ICE MAKING AND DEMOLDING CONTROL METHOD THEREFOR AND CORRESPONDING APPARATUS, AND MEDIUM

(71) Applicant: Shenzhen Intellirocks Tech. Co., Ltd., Shenzhen (CN)

(72) Inventors: Rongshun LIN, Shenzhen (CN); Zubing FAN, Shenzhen (CN); Wenlong WU, Shenzhen (CN)

(21) Appl. No.: 19/572,250

(22) Filed: Mar. 19, 2026

Related U.S. Application Data
(63) Continuation of application No. PCT/CN2024/139549, filed on Dec. 16, 2024.

(30) Foreign Application Priority Data
Jan. 4, 2024 (CN) 2024100136147

(51) Int. Cl. F25C 5/08; F25C 1/10; G01K 1/20; G01K 3/06

(52) U.S. Cl. CPC F25C 5/08; F25C 1/10; G01K 1/20; G01K 3/06; F25C 2500/04; F25C 2600/02; F25C 2600/04; F25C 2700/00; G01K 2213/00

(57) ABSTRACT

An ice maker, an ice making and demolding control method therefor and a corresponding apparatus, and a medium. The method comprises: acquiring the ambient temperature of a physical space where an ice maker is located; on the basis of a first mapping relationship, determining an ice forming duration corresponding to the ambient temperature, and controlling a heat exchange mechanism in the ice maker to make ice according to the ice forming duration; and on the basis of a second mapping relationship, determining an ice releasing duration corresponding to the ambient temperature, and after an ice making process is completed, controlling the heat exchange mechanism in the ice maker to release ice according to the ice releasing duration.

### CROSS-REFERENCE TO RELATED APPLICATIONS

This disclosure is a continuation of International Patent Application No. PCT/CN2024/139549, filed on Dec. 16, 2024, which claims the priority of Chinese Patent Application No. 2024100136147, filed on Jan. 4, 2024, both of which are herein incorporated by reference in their entirety.

### FIELD OF THE TECHNOLOGY

The present disclosure relates to the field of household appliances, and in particular, to an ice maker, a method for controlling ice making and demolding therefor, and a corresponding apparatus, and a medium.

### BACKGROUND OF THE DISCLOSURE

Household ice makers are primarily used in micro-demand scenarios such as homes, stores, and offices. The ice maker makes ice through ice molds, with the final shape typically being bullet-shaped or cube-shaped. Currently, bullet-shaped ice makers and cube-shaped ice makers are popular in the market. The ice maker sequentially absorbs and releases heat from/to the ice-making mold by means of the heat exchange apparatus to realize refrigeration and relative heating, so as to realize ice-making and demolding.

Nowadays, various types of ice makers determine the time for each ice making based on the user's experience or the factory default settings. In short, the heat exchange apparatus is controlled according to the fixed ice-making time to cool the ice-making mold.

### SUMMARY

The present disclosure aims to provide an ice maker, a method for controlling ice making and demolding therefor, and a corresponding apparatus, and a medium.

According to an aspect of the present disclosure, provided is a method for controlling ice making and demolding. The method includes:

acquiring an ambient temperature of a physical space where an ice maker is located;

determining, based on a first mapping relationship, an ice-forming duration corresponding to the ambient temperature, and controlling, according to the ice-forming duration, a heat exchange mechanism in the ice maker to make ice for an ice-making mold in the ice maker; and

determining, based on a second mapping relationship, a deicing duration corresponding to the ambient temperature, and after an ice-making process is completed, controlling, according to the deicing duration, the heat exchange mechanism in the ice maker to perform de-icing for the ice-making mold.

According to another aspect of the present disclosure, provided is an apparatus for controlling ice making and demolding. The apparatus includes:

a temperature acquisition module, configured to acquire an ambient temperature of a physical space where an ice maker is located;

an ice-making control module, configured to determine, based on a first mapping relationship, an ice-forming duration corresponding to the ambient temperature, and control, according to the ice-forming duration, a heat exchange mechanism in the ice maker to make ice for an ice-making mold in the ice maker; and

a deicing control module, configured to determine, based on a second mapping relationship, a deicing duration corresponding to the ambient temperature, and after an ice-making process is completed, control, according to the deicing duration, the heat exchange mechanism in the ice maker to perform de-icing for the ice-making mold.

According to yet another aspect of the present disclosure, provided is an ice maker. The ice maker includes a control unit, a temperature sensor, an ice-making mold, and a heat exchange mechanism, where the control unit is configured to perform the steps of the method for controlling ice making and demolding, so as to determine, based on an ambient temperature collected by the temperature sensor, an ice-forming duration and a deicing duration corresponding to ice-making and de-icing of the ice-making mold by the heat exchange mechanism.

According to still another aspect of the present disclosure, provided is a non-volatile readable storage medium. The non-volatile readable storage medium stores computer programs implemented based on the method for controlling ice making and demolding in a form of computer-readable instructions. The computer programs, when called and run by a computer, cause the computer to perform the steps included in the method.

### BRIEF DESCRIPTION OF THE DRAWINGS

To describe technical solutions of the embodiments of the present disclosure more clearly, the following briefly introduces several accompanying drawings to describe the disclosed embodiments. Apparently, the accompanying drawings in the following description show merely some embodiments of the present disclosure, and a person of ordinary skill in the technology may derive other drawings from these accompanying drawings without creative efforts.

FIG. 1 is a functional block diagram of an electromechanical structure of an exemplary ice maker according to the present disclosure;

FIG. 2 is a functional block diagram of an electric control portion of a heat exchange mechanism of an exemplary ice maker according to the present disclosure;

FIG. 3 is a schematic flowchart of a method for controlling ice making and demolding according to an example of the present disclosure;

FIG. 4 is a schematic flowchart of acquiring an ambient temperature of an ice maker according to an example of the present disclosure;

FIG. 5 is a schematic flowchart of constructing a mapping relationship between a real-time temperature and a compensation temperature according to an example of the present disclosure;

FIG. 6 is a schematic flowchart of determining an ice-forming duration based on an ambient temperature according to an example of the present disclosure;

FIG. 7 is a schematic flowchart of verifying an ice-forming duration according to a minimum ice-bridging time according to an example of the present disclosure;

FIG. 8 is a schematic structural diagram of an apparatus for controlling ice making and demolding according to an example of the present disclosure; and

FIG. 9 is a schematic structural diagram of a computing device according to an example of the present disclosure.

### DETAILED DESCRIPTION

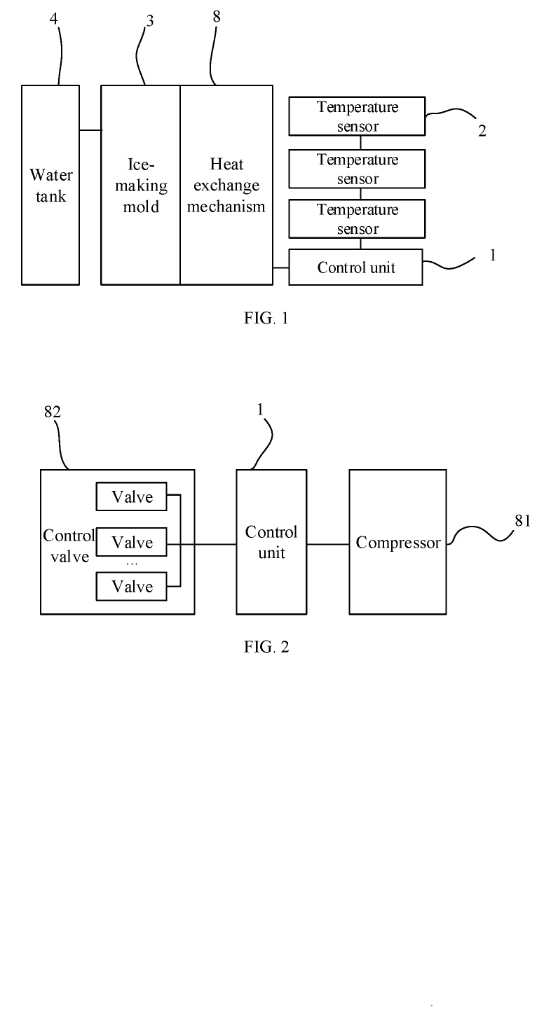

As shown in FIG. 1, the present disclosure exemplarily provides an ice maker. The ice maker includes a control unit 1, a temperature sensor 2, an ice-making mold 3, and a heat exchange mechanism 8. The control unit 1 is configured to control the operation of the whole machine, and the functions realized by the control unit include, but are not limited to, acquiring a real-time temperature collected by the temperature sensor 2, determining a corresponding ambient temperature based on the real-time temperature, determining a corresponding ice-forming duration and deicing duration based on the ambient temperature, and controlling the heat exchange mechanism 8 to perform corresponding ice-making and deicing operations according to the ice-forming duration and the deicing duration. The ice-making mold 3 is provided with a plurality of ice molds, and after each ice mold is filled with liquid, ice cubes can be produced through an ice-making process, and the formed ice cubes can be separated from the ice molds through a deicing process. The ice-making mold 3 may be in communication with a water source such that the water source can provide liquid for the ice-making mold 3. The liquid used for making ice may be aqueous water, and other materials such as cheese and sugar may be added as needed, which does not affect the embodiment of the inventive step of the present disclosure.

In some examples, the water source may serve as a water tank in communication with the ice-making mold 3 and filled with liquid. An ice tank may be provided above the water tank for containing ice cubes after the ice-making mold 3 is demolded, and a water outlet may be provided below the ice tank, such that water droplets melted from the ice cubes in the ice tank can flow back into the water tank for reuse, thereby achieving a water-saving effect. Accordingly, the control unit 1 may control one turning mechanism to transfer a torque to a rotating shaft of the ice-making mold 3, so as to rotate the ice-making mold 3, and may load the slightly melted and loosened ice cubes into the ice tank. It is not difficult to understand that when the melting water of the ice cubes in the water tank falls back to the water tank, the temperature of the liquid in the water tank may be affected to a certain extent, which may also lead to a slight reduction in the required ice-making duration when the liquid in the water tank is subsequently used for ice making.

Referring to FIG. 2, the heat exchange mechanism 8 includes a compressor 81, a condenser, a control valve 82, and an evaporator. The evaporator is in communication with the compressor 81, the compressor 81 is in communication with the condenser, and the condenser is in communication with the evaporator to form an ice-making circuit. A refrigerant passes through the ice-making circuit. When the refrigerant flows to the evaporator, the refrigerant is in an endothermic state in the evaporator to absorb heat from the outside and reduce the temperature of the outside. When the refrigerant flows to the condenser, the refrigerant is in an exothermic state in the condenser to release heat to the outside. The ice-making circuit is controlled by the control valve 82; when the control valve 82 is in an open state, the refrigerant flows through the evaporator to absorb heat, and when the control valve 82 is in a closed state, the refrigerant does not flow through the evaporator, and at this time, the evaporator may gradually heat up under the influence of ambient temperature. Certainly, it may also be set that the control valve 82 is implemented as a reversing valve by means of a pipeline design, such that in a first reversing state, the reversing valve introduces the refrigerant in an endothermic state into the evaporator; and in a second reversing state, the reversing valve introduces the refrigerant in an exothermic state into the evaporator.

The evaporator in the heat exchange mechanism 8 is thermally conductively connected to the ice-making mold 3 to ensure good heat conduction between the evaporator and each ice mold in the ice-making mold 3 and ensure smooth ice-making and de-icing. Both the compressor 81 and the control valve 82 in the heat exchange mechanism 8 are electrically connected to the control unit 1, such that the control unit 1 sends an electrical signal to the control valve 82. In this way, the evaporator can cool or heat the ice-making mold 3, thereby implementing ice-making or de-icing accordingly.

In the present disclosure, one or more temperature sensors 2 may be provided, and are also electrically connected to the control unit 1, thereby providing the collected real-time temperatures to the control unit 1. In terms of the mechanical structure, the respective temperature sensors 2 may be discretely distributed around the ice maker, and may be fixed on the ice maker, for example, fixed on a housing of the ice maker, as long as the actual temperature of the physical space where the ice maker is located is collected as accurately as possible.

For example, the temperature sensor 2 may be an NTC temperature sensor, the cost of which is relatively controllable, and the real-time temperature measured by the NTC temperature sensor may have an error with the actual temperature. Therefore, in order to ensure the accuracy of the real-time temperature collected by the temperature sensor 2, the real-time temperature may also be corrected accordingly as required.

It should be noted that the mechanical structure and the electrical structure of the ice maker of the present disclosure can be implemented in an alternative manner, and are not limited to the above examples; as long as the mechanical structure and the electrical structure implemented by the ice maker still follow the above examples, the method for controlling ice making and demolding of the present disclosure is not prevented from being applied.

In the solution that the present applicant previously attempted to implement, it was found that in the conventional technology, since the ice-making time of the ice maker is generally fixedly set based on experimental or empirical values, the formation of ice cubes can be ensured in most cases, but it may also lead to abnormalities, mainly because the ambient temperature of the space where the ice maker is located changes with the weather; at different ambient temperatures, during the first several rounds of ice making after the ice maker is turned on, the operating temperature of the device of the ice maker changes, and the liquid temperature and the ambient temperature generally also change in association, and there are a plurality of variables, resulting in that when the first several rounds of ice making are performed according to the fixedly set ice-making time, sometimes ice cubes cannot be completely formed, and sometimes a plurality of ice cubes are frozen into a piece of ice, which is commonly known as ice bridging. These phenomena may be regarded as an ice-making failure to some extent. Only after various variables are relatively stable, the ice formation quality of the ice maker may tend to be relatively stable.

Moreover, in addition to the fact that the ice-making effect of the first several rounds cannot be guaranteed, when the ambient temperature is too low, performing ice making according to the fixedly set ice-making time may lead to ice bridging due to the influence of the too low ambient temperature. Once the ice bridging occurs, it may affect the demolding of the ice cubes, resulting in the failure of the ice maker to operate normally.

In order to solve one of the above problems, according to the above exemplary product architecture and operating principle of an ice maker, the method for controlling ice making and demolding of the present disclosure can be implemented as a computer program product, which is stored in a memory inside a control unit 1 of the ice maker. The computer program product, when called and run by a central processing unit in the control unit 1 from the memory, causes the control unit to determine, based on an ambient temperature collected by each temperature sensor 2, an ice-forming duration and a deicing duration corresponding to ice making and de-icing of an ice-making mold 3 by a heat exchange mechanism 8, and control the heat exchange mechanism 8 to operate according to the corresponding ice-forming duration and the deicing duration, thereby achieving the whole-process automatic operation of ice making and de-icing.

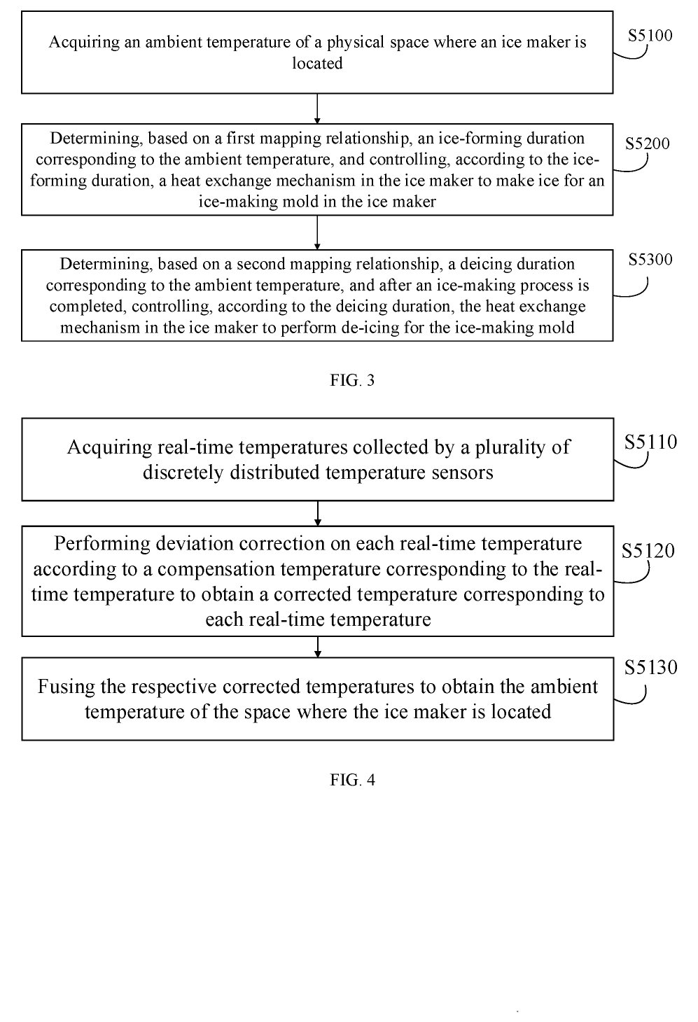

Referring to FIG. 3, in one example, provided is a method for controlling ice making and demolding of the present disclosure, which is executed by a control unit of an ice maker. The method includes:

In step S5100, an ambient temperature of a physical space where an ice maker is located is acquired.

When ice cubes need to be produced, the ice maker of the present disclosure may be used to make ice, and after the ice-making process is completed, de-icing and even demolding may be performed. After the ice maker is started, one or more temperature sensors electrically connected to the control unit of the ice maker enter into an operating state to continuously collect temperature data, and the control unit may determine, based on the temperature data, the ambient temperature of the physical space where the ice maker is currently located, thereby effectively measuring the actual temperature of the physical space.

In an example in which the ambient temperature is determined using temperature data of a plurality of temperature sensors, the plurality of temperature sensors are relatively discretely distributed, and corresponding temperature data are determined at different positions relative to the ice maker. Then, the respective temperature data may be fused to determine a single ambient temperature as the actual temperature of the physical space. The ambient temperature may be uniformly expressed in degrees Celsius or in Kelvin, and neither representation affects the embodiment of the inventive step of the present disclosure.

In step S5200, an ice-forming duration corresponding to the ambient temperature is determined based on a first mapping relationship, and a heat exchange mechanism in the ice maker is controlled to make ice for an ice-making mold in the ice maker according to the ice-forming duration.

There is a linear relationship between the ambient temperature and the ice-forming duration, and a mapping relationship between the ambient temperature and the ice-forming duration is preset as the first mapping relationship. A representation form of the first mapping relationship may be flexibly set. In one example, the first mapping relationship may be represented as a mapping relationship table. In another example, the first mapping relationship may be represented as a data formula after data fitting. It is not difficult to understand that, based on the linear relationship between the ambient temperature and the ice-forming duration, after the first mapping relationship is determined in advance, given an ambient temperature, its corresponding ice-forming duration can be determined based on the first mapping relationship.

The first mapping relationship may be constructed based on a pre-prepared first data source. The first data source for constructing the first mapping relationship may be obtained by actually measuring the ice maker or the products of the same batch thereof, and acquiring the ice-forming duration from the moment when the heat exchange mechanism is controlled to start ice making to the moment when ice cubes in the ice-making mold just form and no ice cubes are connected with each other when each ice maker actually makes ice based on the ambient temperature corresponding to each ice-making round under a plurality of ice-making rounds, such that each ambient temperature has its corresponding ice-forming duration to constitute a data pair, and the data pair may be used to construct the first mapping relationship.

After the ice-forming duration corresponding to the ambient temperature is determined based on the first mapping relationship, the ice-forming duration may be set as the corresponding operating duration for the heat exchange mechanism of the ice maker to implement ice making for the ice-making mold, and then the heat exchange mechanism is started to operate to implement the ice-making process for the liquid in each ice mold in the ice-making mold.

Specifically, the control unit may set a timer according to the determined ice-forming duration, start the timer to start timing, synchronously control the compressor in the heat exchange mechanism to start operating, and at the same time switch the control valve in the heat exchange mechanism to enable the refrigerant to act on the evaporator, such that the evaporator operates in an endothermic state relative to the ice-making mold. The heat of the ice-making mold is taken away by the refrigerant to achieve cooling, and during the cooling process, the liquid in the ice mold gradually freezes. When the timer set by the control unit calculates the end of the ice-forming duration, the control unit can stop operating and prevent the passage of the refrigerant for heat absorption in the evaporator. At this time, the liquid in the ice mold of the ice-making mold just turns into ice cubes in good shape, and there is basically no connection between the ice cubes, facilitating a good ice formation effect.

It can be seen that since the first mapping relationship has been preset, and the relationship between the ambient temperature and the corresponding optimal ice-forming duration has been defined in the first mapping relationship in advance, when the ambient temperature is given, the corresponding ice-forming duration can be quickly determined, and the automatic refrigeration control of the heat exchange mechanism can be completed without manual intervention. The ambient temperature itself is a result of integrating the influence of various possible variables, and for example, the influence of the demolded ice cubes on the air temperature of the physical space will also be reflected in the ambient temperature. Although the ambient temperature may change constantly during multiple rounds of ice making by the ice maker, the change in the ice-forming duration corresponding to this change may also be determined based on the first mapping relationship. Therefore, no matter whether the ice maker is making ice in the first round or previous rounds, it can be ensured that the heat exchange mechanism is controlled to perform ice-making according to the ambient temperature of each round and the corresponding optimal ice-forming duration.

In step S5300, a deicing duration corresponding to the ambient temperature is determined based on a second mapping relationship, and after an ice-making process is completed, the heat exchange mechanism in the ice maker is controlled to perform de-icing for the ice-making mold according to the deicing duration.

Similarly, there is also a linear relationship between the ambient temperature and the deicing duration, and a mapping relationship between the ambient temperature and the deicing duration is preset as the second mapping relationship. Similarly, a representation form of the second mapping relationship may be flexibly set. In one example, the second mapping relationship may be represented as a mapping relationship table. In another example, the second mapping relationship may be represented as a data formula after data fitting. It is not difficult to understand that after the second mapping relationship is determined in advance based on the linear relationship between the ambient temperature and the deicing duration, given an ambient temperature, the corresponding deicing duration can be determined based on the second mapping relationship.

The second mapping relationship may be constructed based on a pre-prepared second data source. The second data source for constructing the second mapping relationship may be obtained by actually measuring the ice maker or products of the same batch thereof, and acquiring the deicing duration from the moment when the ice maker actually starts to deice to the moment when ice cubes in the ice-making mold are just separated from the ice molds based on the ambient temperature corresponding to each ice-making round under a plurality of ice-making rounds, such that each ambient temperature has its corresponding deicing duration to constitute a data pair, and the data pair may be used to construct the second mapping relationship.

After the deicing duration corresponding to the ambient temperature is determined based on the second mapping relationship, the deicing duration may be set as an operating duration corresponding to the de-icing of the ice-making mold by the heat exchange mechanism of the ice maker, and then the heat exchange mechanism is started to operate to implement the de-icing process of the ice cubes in the ice molds in the ice-making mold.

Specifically, the control unit may set a timer according to the determined deicing duration, start the timer to start timing, synchronously control the compressor in the heat exchange mechanism to start operating, and at the same time switch the control valve in the heat exchange mechanism to enable the refrigerant not to flow into the evaporator, or to function to release heat although flowing into the evaporator, such that the evaporator operates in an exothermic state relative to the ice-making mold. Due to the relative heat releaseeffect, the temperature of the ice-making mold gradually rises to achieve the temperature rise, and during the process of temperature rise, the outer layers of the ice cubes in the ice molds gradually melt first. When the timer set by the control unit calculates that the deicing duration has just ended, the control unit can stop operating and prevent the evaporator from playing a relative heat release role. At this time, the ice molds of the ice-making mold are just separated from the ice cubes therein, such that the ice cubes are easier to release, facilitating a good deicing effect. Further, according to actual needs, the control unit may further control the ice-making mold to turn over, such that the ice cubes that have been released in the ice molds fall into the ice tank of the ice maker under the action of their own weights to complete the demolding work of one ice-making round.

It can be seen that since the second mapping relationship has been preset, and the relationship between the ambient temperature and the corresponding optimal deicing duration has been defined in the second mapping relationship in advance, when the ambient temperature is given, the corresponding deicing duration can be quickly determined, and the automatic refrigeration control of the heat exchange mechanism can be completed without manual intervention. The ambient temperature itself is a result of integrating the influence of various possible variables, and for example, the influence of the demolded ice cubes on the air temperature of the physical space may also be reflected in the ambient temperature. Although the ambient temperature may change constantly during multiple rounds of ice making by the ice maker, the change in the deicing duration corresponding to this change may also be determined based on the second mapping relationship. Therefore, no matter whether the ice maker is making ice in the first round or previous rounds, it can be ensured that the heat exchange mechanism is controlled to perform de-icing according to the ambient temperature of each round and the corresponding optimal deicing duration.

On the basis of the above example, it is not difficult to understand that, the present disclosure first acquires an ambient temperature of a physical space where an ice maker is located; to meet the needs of ice making, it determines an ice-forming duration required for cooling in the ice-making process based on the ambient temperature by using a first mapping relationship between the ambient temperature and the ice-forming duration, and controls a heat exchange apparatus of the ice maker to operate according to the ice-forming duration to continuously cool an ice-making mold to achieve refrigeration, thereby allowing the ice cubes to form; and to meet the needs of demolding after the ice cubes are formed, it determines a deicing duration required for heating in the demolding process based on the ambient temperature by using a second mapping relationship between the ambient temperature and the deicing duration, and controls the heat exchange apparatus of the ice maker to operate according to the deicing duration to continuously cool the ice-making mold to slightly melt and release the ice cubes formed in the ice-making mold, thereby achieving demolding. Therefore, the present disclosure intelligently and adaptively determines the ice-forming duration and the deicing duration based on the ambient temperature, thereby flexibly controlling the whole ice-making process of the ice maker, such that the ice-making time and the deicing time of the ice maker are controlled without the interference of various variables, especially without the interference of the ambient temperature change of the physical space where the ice maker is located and the operating temperature of the ice maker itself, and in addition, ice cubes with complete shapes can be prepared without ice connection between the ice cubes. Therefore, the output quality of the ice maker is effectively improved, and the popularization and application of the ice maker are facilitated.

On the basis of any example of the method of the present disclosure, referring to FIG. 4, acquiring the ambient temperature of the physical space where the ice maker is located includes:

In step S5110, real-time temperatures collected by a plurality of discretely distributed temperature sensors are acquired.

As disclosed above, a plurality of temperature sensors may be arranged on the ice maker, and the respective temperature sensors may be relatively discretely distributed, for example, some arranged close to the ice-making mold and some arranged away from the ice-making mold. The temperature data collected by the plurality of temperature sensors, i.e., the real-time temperatures, may be different from one another due to their varying distances from the heat exchange mechanism and the ice-making mold in the ice maker, and may be fused subsequently.

In step S5120, deviation correction is performed on each real-time temperature according to a compensation temperature corresponding to the real-time temperature to obtain a corrected temperature corresponding to each real-time temperature.

There is often a deviation between the real-time temperature actually measured by the temperature sensor and the actual ambient temperature, and the deviation may be overcome by compensating the real-time temperature measured by each temperature sensor. Accordingly, the ice maker may be placed in an experimental environment to perform multiple rounds of ice making, an error temperature between a corresponding real-time temperature and an ambient temperature is acquired at each ice-making round to form a data pair of the real-time temperature and the error temperature; a mapping relationship between the real-time temperature and the error temperature thereof is determined after data fitting; in the case of the real-time temperature of the temperature sensor, the corresponding error temperature may be obtained based on the mapping relationship as a compensation temperature corresponding to the real-time temperature.

It is not difficult to understand that each temperature sensor has a mapping relationship between its corresponding real-time temperature and its error temperature. Accordingly, the real-time temperature measured by each temperature sensor can determine its corresponding compensation temperature based on the mapping relationship of the corresponding temperature sensor.

Each real-time temperature and a corresponding compensation temperature are added and summed, such that deviation correction is performed on the real-time temperature, thereby obtaining a corresponding corrected temperature.

In step S5130, the respective corrected temperatures are fused to obtain the ambient temperature of the space where the ice maker is located.

Since the ice maker uses a plurality of temperature sensors to collect temperature data to obtain corresponding corrected temperatures, the corrected temperatures themselves may also be different from one another, and accordingly, these corrected temperatures need to be fused into a same ambient temperature.

In one example, when the ambient temperature is determined based on the corrected temperature corresponding to each temperature sensor, the arithmetic mean value of the respective corrected temperatures may be directly calculated, and the resulting mean value is taken as the ambient temperature, thereby achieving efficient operation.

In another example, considering the distribution of the temperature sensors at different positions relative to the ice maker, the measurement of the actual temperature of the physical space where the ice maker is located has different degrees of deviation. For example, the corrected temperature corresponding to the real-time temperature measured by the temperature sensor near an air outlet of the heat exchange mechanism of the ice maker may be slightly higher than the corrected temperature corresponding to the real-time temperature measured by the temperature sensor far away from the air outlet. Similarly, the corrected temperature corresponding to the temperature sensor near the ice-making mold and the evaporator may also be lower than the corrected temperature corresponding to the temperature sensor far away from the ice-making mold and the evaporator. In this case, the weights corresponding to the respective temperature sensors may be preset, and the weighted mean value of the corrected temperatures corresponding to the respective temperature sensors may be calculated based on these weights as the ambient temperature. The ambient temperature thus determined can generally more accurately reflect the actual temperature of the physical space where the ice maker is located.

The above example shows that the real-time temperature of the physical space where the ice maker is located is collected by using a plurality of temperature sensors, the compensation temperature corresponding to each real-time temperature is determined by using a prior mapping relationship to correct the real-time temperature to obtain the corrected temperature, and then the corrected temperatures are fused to determine the ambient temperature of the physical space. The use of the ambient temperature to represent the actual temperature of the physical space is more accurate, and on the basis of the accurate ambient temperature, more accurate ice-forming duration and deicing duration can be obtained, thereby ensuring that the ice maker can stably, efficiently and accurately implement multiple rounds of ice-making and de-icing process.

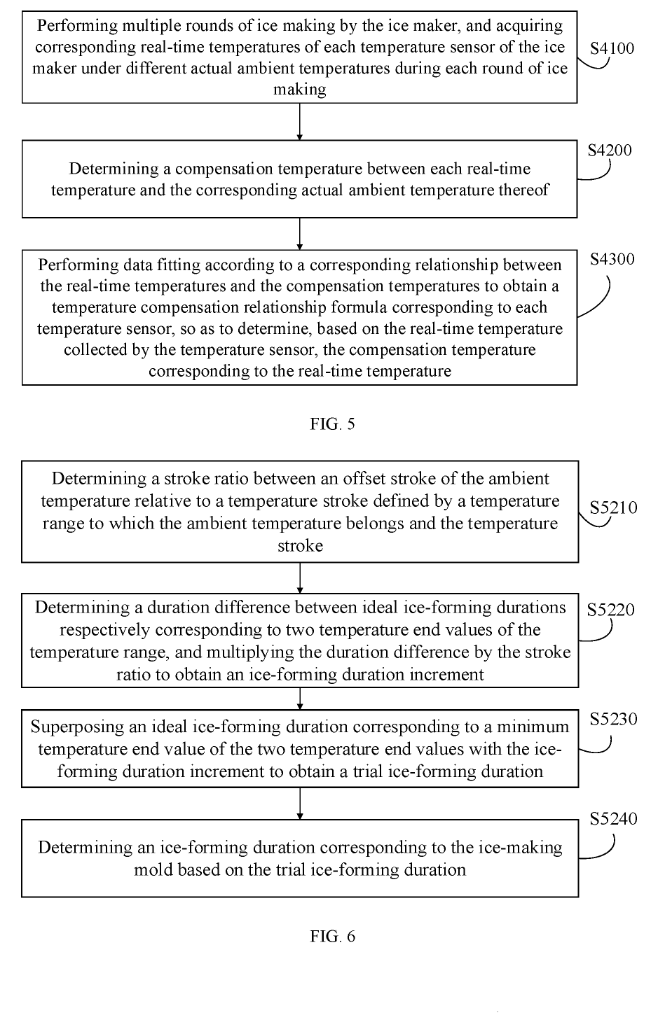

On the basis of any example of the method of the present disclosure, the mapping relationship between the real-time temperature actually measured by each temperature sensor and the error temperature thereof relative to the actual ambient temperature at the time of actual measurement may be further determined by means of the present example. Accordingly, referring to FIG. 5, before performing deviation correction on the real-time temperature according to the compensation temperature corresponding to each real-time temperature to obtain the corrected temperature corresponding to each real-time temperature, the method includes:

In step S4100, multiple rounds of ice making are performed by the ice maker, and corresponding real-time temperatures of each temperature sensor of the ice maker under different actual ambient temperatures are acquired during each round of ice making.

One or more batches of produced ice makers are prepared, and multiple rounds of ice-making process are performed by using each ice maker. When each ice maker starts to implement each round of ice-making process, the temperature at that time is read as the actual ambient temperature by a temperature measurement tool outside the ice maker, and the real-time temperature measured by each temperature sensor of the ice maker at that time, such that the actual ambient temperature and the real-time temperature form a data pair.

In step S4200, a compensation temperature between each real-time temperature and the corresponding actual ambient temperature thereof is determined, where a compensation temperature corresponding to a real-time temperature measured by the temperature sensor during a first round of ice making is set as a mean value of error temperatures between the real-time temperatures and the corresponding actual ambient temperatures separately measured by the ice maker in a warm machine state and a cold machine state.

For each data pair, an error temperature between the actual ambient temperature and the real-time temperature may be obtained by subtracting the real-time temperature from the actual ambient temperature, that is, a compensation temperature. The data pairs between the real-time temperatures and the compensation temperatures may be further obtained by determining the compensation temperatures of the respective data pairs one by one.

Given that it is impossible to predetermine whether the ice maker is in a warm machine state or a cold machine state before the first ice-making round is started in actual use of the ice maker, and the compensation temperatures in the warm machine state and the cold machine state are different, in this case, a corresponding data pair can be provided during the first round of ice making. Accordingly, based on the same real-time temperature, the ice maker can be controlled to start the first round of ice making in the warm machine state and the cold machine state separately, the corresponding real-time temperature and the corresponding compensation temperature can be determined, and then the compensation temperature in the warm machine state and the compensation temperature in the cold machine state are summed and averaged. The resulting mean value and the real-time temperature form a data pair. Through such processing, the data pairs corresponding to the first round of ice making can be prevented from being outliers, and when data fitting is performed subsequently, it can be ensured that the fitted formula can more accurately reflect the mapping relationship between the real-time temperature of the temperature sensor and the compensation temperature.

In step S4300, data fitting is performed according to a corresponding relationship between the real-time temperatures and the compensation temperatures to obtain a temperature compensation relationship formula corresponding to each temperature sensor, so as to determine, based on the real-time temperature collected by the temperature sensor, the compensation temperature corresponding to the real-time temperature.

In addition to determining the data pairs of the real-time temperatures and the compensation temperatures, data fitting can be performed based on these data pairs to fit the mapping relationship between the real-time temperature and the compensation temperature. It is not difficult to understand that the real-time temperature and the compensation temperature are in a linear relationship, and thus a corresponding temperature compensation relationship formula can be obtained. Through the temperature compensation relationship formula, the compensation temperature corresponding to the given real-time temperature can be determined.

On the basis of the above example, a mapping relationship between a real-time temperature measured by each temperature sensor of an ice maker and a compensation temperature thereof can be determined in advance, and after the mapping relationship is fitted into a temperature compensation relationship formula, a compensation temperature corresponding to the real-time temperature actually measured by the temperature sensor is determined conveniently based on the real-time temperature measured by the temperature sensor. Since the data pair corresponding to whether the ice maker is in the warm machine state or the cold machine state before the first round of ice making of the ice maker is forcibly set before the mapping relationship is determined, it can be ensured that the temperature compensation relationship formula after data fitting can more accurately reflect the linear relationship between the real-time temperature of the temperature sensor and the compensation temperature thereof. Therefore, the compensation temperature determined based on this is more accurate, and can provide a reliable basis for subsequent operations.

On the basis of any example of the method of the present disclosure, referring to FIG. 6, determining, based on the first mapping relationship, the ice-forming duration corresponding to the ambient temperature includes:

In step S5210, a stroke ratio between an offset stroke of the ambient temperature relative to a temperature stroke defined by a temperature range to which the ambient temperature belongs and the temperature stroke is determined.

The first mapping relationship between the ambient temperature and the corresponding ice-forming duration thereof may be constructed in advance. In this example, the temperature partitioning approach is adopted to constrain the mapping relationship between the ambient temperatures within different temperature ranges and the corresponding ice-forming durations. Accordingly, when the ambient temperature of the ice maker is determined, according to each pre-divided temperature range, the temperature range, such as 23° C. to 28° C., to which the ambient temperature, such as 25° C., belongs is queried first. The temperature range actually defines a temperature stroke; for example, a temperature stroke of 5° C. exists between 23° C. and 28° C. Further, based on a minimum temperature end value (such as 23° C.) of the temperature range, a difference between the ambient temperature and the minimum temperature end value may be calculated as 2° C., which is used as an offset stroke of the ambient temperature relative to the temperature stroke defined by the temperature range to which the ambient temperature belongs. Further, the offset stroke is divided by the temperature stroke to obtain a corresponding ratio value as the stroke ratio.

In step S5220, a duration difference between ideal ice-forming durations respectively corresponding to two temperature end values of the temperature range is determined, and the duration difference is multiplied by the stroke ratio to obtain an ice-forming duration increment.

The two temperature end values of the temperature range are referred to as the maximum temperature end value and the minimum temperature end value, and the corresponding ideal ice-forming durations are both determined in advance. The ideal ice-forming duration may be an empirical value or an experimental value, and may be set such that when ice making is implemented at a corresponding temperature end value and continues until the theoretical ice-forming duration stops, the liquid in the ice molds in the ice-making mold just turns into ice cubes. The mapping relationship between the temperature end value and the ideal ice-forming duration may be stored in the form of a mapping relationship table. In this way, it is only necessary to predetermine ideal ice-forming durations corresponding to several temperature end values, which may be used to determine a corresponding ice-forming duration for any given ambient temperature in this example.

Ideal ice-forming durations corresponding to the maximum temperature end value and the minimum temperature end value of the temperature range are acquired, and an absolute difference between the two is calculated, such that a duration difference may be obtained as an ice-forming time distance. Further, the stroke ratio calculated in the previous step is multiplied by the ice-forming time distance to obtain an ice-forming duration increment.

In step S5230, an ideal ice-forming duration corresponding to a minimum temperature end value of the two temperature end values is superposed with the ice-forming duration increment to obtain a trial ice-forming duration.

The physical quantity corresponding to the ice-forming duration increment determined above is a time width allocated based on the ice-forming time distance between the ambient temperature and the two temperature end values of the temperature range to which the ambient temperature belongs. This time width is also a time difference that needs to be extended relative to the ideal ice-forming duration corresponding to the minimum temperature end value in the temperature range to which the ambient temperature belongs when ice cubes form in ice-making rounds under the given ambient temperature. Accordingly, it is only necessary to add the ice-forming duration increment to the ideal ice-forming duration corresponding to the minimum temperature end value in the temperature range to obtain a sum value, which may be used as the trial ice-forming duration.

In step S5240, an ice-forming duration corresponding to the ice-making mold is determined based on the trial ice-forming duration.

The preliminarily determined trial ice-forming duration may generally be directly used as the ice-forming duration corresponding to the ambient temperature. In some examples, the trial ice-forming duration may be further verified before determining whether to use it as the ice-forming duration corresponding to the ambient temperature.

It can be seen that there is a linear relationship between each temperature end value used to define each temperature range and its ideal ice-forming duration, there is also a linear relationship between the ambient temperature and its stroke ratio, and there is also a linear relationship between the stroke ratio and the ice-forming duration increment. Accordingly, a given ambient temperature ultimately has a unique ice-forming duration corresponding thereto, and such a corresponding relationship constitutes the second mapping relationship.

On the basis of the above example, it can be seen that temperature ranges are used for temperature partitioning, an ice-forming duration increment of an ice-forming time distance of an ambient temperature relative to a temperature range to which the ambient temperature belongs is determined based on a stroke ratio of an offset stroke of the ambient temperature deviating from the minimum temperature end value in the temperature range relative to a temperature stroke defined by two temperature end values of the temperature range; and then an ice-forming duration corresponding to the ambient temperature is determined by superposing the ice-forming duration increment and an ideal ice-forming duration of the minimum temperature end value. The ice-forming duration derived from this extremely fine granularity is more accurate, ensuring accurate control over ice formation when the ice-formation duration is applied to the ice-making operation control of the heat exchange mechanism.

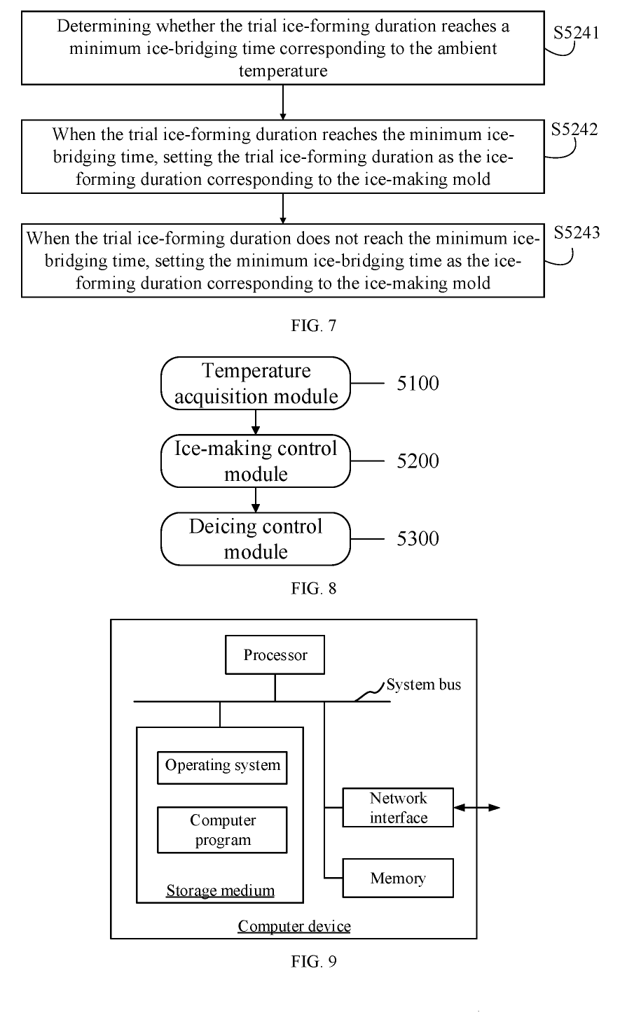

On the basis of any example of the method of the present disclosure, referring to FIG. 7, determining the ice-forming duration corresponding to the ice-making mold based on the trial ice-forming duration includes:

In step S5241, whether the trial ice-forming duration reaches a minimum ice-bridging time corresponding to the ambient temperature is determined.

As disclosed in the previous example, generally, in the case where the trial ice-forming duration corresponding to the ambient temperature is determined based on the second mapping relationship, the trial ice-forming duration may be directly used as the ice-forming duration corresponding to the ambient temperature in most scenarios. However, in order to further improve the robustness of the ice-making process of the ice maker and prevent the ice-forming duration from being inaccurate due to other abnormalities, the trial ice-forming duration may be further verified. Accordingly, it is first determined whether the trial ice-forming duration reaches a minimum ice-bridging time corresponding to the actually measured ambient temperature.

There is also a linear relationship between the minimum ice-bridging time and the ambient temperature. Thus, similarly, a mapping relationship thereof may be preset and constructed, which may be referred to as a third mapping relationship, and corresponding data between the minimum ice-bridging time and the actual ambient temperature is stored as a mapping relationship table, or the linear relationship therebetween is implemented as a mathematical formula. Accordingly, when the minimum ice-bridging time corresponding to the ambient temperature needs to be determined, the minimum ice-bridging time is determined by looking up a table or applying a mathematical formula.

As disclosed above, the minimum ice-bridging time may be a moment starting from a moment when each ice-making round starts, continuing until ice cubes form in the ice-making mold, and further extending to a moment when some ice cubes are first connected, which may be usually 1-3 seconds slightly earlier than this moment. The resulting time length may be regarded as the minimum ice-bridging time.

In step S5242, when the trial ice-forming duration reaches the minimum ice-bridging time, the trial ice-forming duration is set as the ice-forming duration corresponding to the ice-making mold.

When the trial ice-forming duration determined based on the ambient temperature reaches the minimum ice-bridging time corresponding to the ambient temperature, it usually indicates that the ice-forming duration is abnormal. In this case, in order to ensure the stability of the ice maker, the ice-forming duration corresponding to the ambient temperature may be replaced with the minimum ice-bridging time corresponding to the ambient temperature, that is, the minimum ice-bridging time is taken as the ice-forming duration actually used, and the heat exchange mechanism is controlled to continuously perform ice-making according to the minimum ice-bridging time, thereby ensuring that the formation of ice cubes can still be successfully completed at the current time, and no connection is generally generated between the ice cubes, or the ice cubes are easier to separate during de-icing or demolding even if they are slightly connected. It can be seen that the minimum ice-bridging time can serve as a minimum guarantee to prevent ice-bridging.

In step S5243, when the trial ice-forming duration does not reach the minimum ice-bridging time, the minimum ice-bridging time is set as the ice-forming duration corresponding to the ice-making mold.

When the trial ice-forming duration determined based on the ambient temperature does not reach the minimum ice-bridging time corresponding to the ambient temperature, it indicates that the determined ice-forming duration is reliable. At this time, the heat exchange mechanism can be controlled to continuously perform ice-making according to the directly determined ice-forming duration through the verification of the ice-forming duration.

On the basis of the above example, it can be seen that by means of the mapping relationship between the ambient temperature and the minimum ice-bridging time, the ice-forming duration determined based on the ambient temperature is verified by using the minimum ice-bridging time corresponding to the ambient temperature. When the ice-forming duration reaches or exceeds the minimum ice-bridging time, the minimum ice-bridging time is used as the ice-forming time actually used, and the former is replaced to control the heat exchange mechanism to implement the refrigeration work. When the ice-forming duration does not reach the minimum ice-bridging time, it indicates that the determined ice-forming duration is relatively reliable and passes the verification, and the heat exchange mechanism is controlled to implement the refrigeration work according to the ice-forming duration. Accordingly, it can be seen that the minimum ice-bridging time can provide a basis for the reliability verification of the ice-forming time, and can further provide fallback data when the ice-forming duration is abnormal, which can ensure that the ice maker is more robust when implementing refrigeration, and can ensure that the formation of ice cubes can be successfully completed in each ice-making round.

On the basis of any example of the method of the present disclosure, before determining the ice-forming duration corresponding to the ice-making mold based on the trial ice-forming duration, the method includes:

In step S3100, an elapsed time when a plurality of ice molds in the ice-making mold reach a connected frozen state in the case that the ice maker makes ice at a plurality of ambient temperatures is collected as an ice-bridging time at the corresponding ambient temperature.

The mapping relationship between the ambient temperature and the minimum ice-bridging time may be constructed in advance. In this example, one or more ice makers are used in advance, each ice maker is used to implement multiple rounds of ice-making operations, and an actual ambient temperature at which the ice-making is started is determined; and then an elapsed time from the moment when each ice-making round is started to the moment when ice cubes in some ice molds in the ice-making mold are in a connected frozen state is determined, and this time is taken as the corresponding ice-bridging time under the actual ambient temperature, and the actual ambient temperature and the ice-bridging time form a data pair. A large number of data pairs can be obtained by performing multiple rounds of ice-making by a plurality of ice makers, separately.

In step S3200, data fitting is performed according to a corresponding relationship between the ambient temperature and the ice-bridging time corresponding thereto, and an ice-bridging time formula is determined, so as to determine the corresponding ice-bridging time based on the ambient temperature as the minimum ice-bridging time.

The actual ambient temperature and the ice-bridging time in each data pair are mapped to a coordinate system to obtain coordinate points, and an ice-bridging time formula can be determined by performing data fitting on the coordinate points. It is not difficult to understand that the ice-bridging time formula also describes a mapping relationship between the ambient temperature and the ice-bridging time, i.e., a third mapping relationship. Subsequently, when an ambient temperature is given, the ambient temperature is substituted into the ice-bridging time formula for calculation to obtain the corresponding ice-bridging time, which can be taken as the minimum ice-bridging time corresponding to the ambient temperature.

On the basis of the above example, it can be seen that by fitting a mathematical formula between the ambient temperature and the minimum ice-bridging time, it is very convenient to subsequently determine the corresponding minimum ice-bridging time based on the ambient temperature, which can realize automatic calculation for computer programs, and improve the intelligence degree of the verification decision of the ice-forming duration.

On the basis of any example of the method of the present disclosure, determining, based on a second mapping relationship, a deicing duration corresponding to the ambient temperature includes:

In step S5310, a mapping value of a temperature range to which the ambient temperature belongs is determined.

As disclosed above, a second mapping relationship is formed between the ambient temperature and the deicing duration of the ice maker. Generally, in the case where a plurality of temperature ranges are set, based on the temperature range of the lowest temperature, the higher the temperature is, the smaller the corresponding deicing duration is. This change relationship changes in a gradient manner. According to this rule, the corresponding deicing durations of the ice maker under different actual ambient temperatures can be collected in advance, and the actual ambient temperature and the corresponding deicing duration form a data pair. Further, considering the rule and the need to reduce the amount of calculation, the respective temperature ranges may be sequentially mapped into the form of ordered values, the mapping value corresponding to the temperature range to which the actual ambient temperature belongs is determined based on the actual ambient temperature, and the corresponding actual ambient temperature in the data pair is replaced with the mapping value, thereby obtaining the data pair of the mapping value and the deicing duration for the temperature range. A mathematical formula obtained by performing data fitting on a plurality of such data pairs can be used as a demolding attenuation formula.

Accordingly, when the ice maker determines its corresponding ambient temperature, the temperature range to which the ambient temperature belongs can be determined based on the ambient temperature, and then the mapping value corresponding to the temperature range can be determined.

In step S5320, a deicing duration corresponding to the mapping value is determined based on a preset demolding attenuation formula, where the demolding attenuation formula defines that the higher a temperature represented by the temperature range, the shorter the deicing duration determined based on the mapping value of the temperature range.

The deicing duration corresponding to the mapping value can be obtained by substituting the mapping value determined based on the ambient temperature into the demolding attenuation formula for calculation. Based on the construction principle of the demolding attenuation formula, it is not difficult to understand that the higher the temperature indicated by the temperature range to which the ambient temperature belongs, the shorter the corresponding deicing duration, which is consistent with the law of fact.

On the basis of the above example, it can be seen that the second mapping relationship between the ambient temperature and the corresponding deicing duration thereof can also be fitted as a mathematical formula. When the ice maker is operating, and the ambient temperature is determined, the corresponding deicing duration can be quickly determined based on the mathematical formula, such that the heat exchange mechanism can be controlled to successfully complete de-icing according to the deicing duration, and further demolding can be implemented. The whole process can be automatically implemented, thereby greatly improving the intelligence degree of the ice maker.

Referring to FIG. 8, another example of the present disclosure further provides an apparatus for controlling ice making and demolding, including a temperature acquisition module 5100, an ice-making control module 5200, and a deicing control module 5300, where the temperature acquisition module 5100 is configured to acquire an ambient temperature of a physical space where an ice maker is located; the ice-making control module 5200 is configured to determine, based on a first mapping relationship, an ice-forming duration corresponding to the ambient temperature, and control, according to the ice-forming duration, a heat exchange mechanism in the ice maker to make ice for an ice-making mold in the ice maker; and the deicing control module 5300 is configured to determine, based on a second mapping relationship, a deicing duration corresponding to the ambient temperature, and after an ice-making process is completed, control, according to the deicing duration, the heat exchange mechanism in the ice maker to perform de-icing for the ice-making mold.

On the basis of any example of the method of the present disclosure, the temperature acquisition module 5100 includes: a collection and acquisition unit configured to acquire real-time temperatures collected by a plurality of discretely distributed temperature sensors; a temperature compensation unit configured to perform deviation correction on each real-time temperature according to a compensation temperature corresponding to the real-time temperature to obtain a corrected temperature corresponding to each real-time temperature; and a temperature fusion unit configured to fuse the respective corrected temperatures to obtain the ambient temperature of the space where the ice maker is located.

On the basis of any example of the method of the present disclosure, prior to the operation of the temperature compensation unit, the apparatus for controlling ice making and demolding of the present disclosure includes: a temperature sample acquisition module configured to perform multiple rounds of ice making by the ice maker, and acquire corresponding real-time temperatures of each temperature sensor of the ice maker under different actual ambient temperatures during each round of ice making; a compensation temperature determination module configured to determine a compensation temperature between each real-time temperature and the corresponding actual ambient temperature thereof, where a compensation temperature corresponding to a real-time temperature measured by the temperature sensor during the first round of ice making is set as a mean value of error temperatures between the real-time temperatures and the corresponding actual ambient temperatures separately measured by the ice maker in a warm machine state and a cold machine state; and a compensation formula fitting module configured to perform data fitting according to a corresponding relationship between the real-time temperatures and the compensation temperatures to obtain a temperature compensation relationship formula corresponding to each temperature sensor, so as to determine, based on the real-time temperature collected by the temperature sensor, the compensation temperature corresponding to the real-time temperature.

On the basis of any example of the method of the present disclosure, the ice-making control module 5200 includes: a ratio analysis unit configured to determine a stroke ratio between an offset stroke of the ambient temperature relative to a temperature stroke defined by a temperature range to which the ambient temperature belongs and the temperature stroke; an increment analysis unit configured to determine a duration difference between ideal ice-forming durations respectively corresponding to two temperature end values of the temperature range, and multiply the duration difference by the stroke ratio to obtain an ice-forming duration increment; a duration trial calculation unit configured to superpose an ideal ice-forming duration corresponding to a minimum temperature end value of the two temperature end values with the ice-forming duration increment to obtain a trial ice-forming duration; and a duration determination unit configured to determine an ice-forming duration corresponding to the ice-making mold based on the trial ice-forming duration.

On the basis of any example of the method of the present disclosure, the duration determination unit includes: a verification and decision subunit configured to determine whether the trial ice-forming duration reaches a minimum ice-bridging time corresponding to the ambient temperature; a first configuration subunit configured to set, when the trial ice-forming duration reaches the minimum ice-bridging time, the trial ice-forming duration as the ice-forming duration corresponding to the ice-making mold; and a second configuration subunit configured to set, when the trial ice-forming duration does not reach the minimum ice-bridging time, the minimum ice-bridging time as the ice-forming duration corresponding to the ice-making mold.

On the basis of any example of the method of the present disclosure, prior to the operation of the duration determination unit, the apparatus for controlling ice making and demolding of the present disclosure includes: an ice-bridging data collection module configured to collect an elapsed time when a plurality of ice molds in the ice-making mold reach a connected frozen state in a case that the ice maker makes ice at a plurality of ambient temperatures as an ice-bridging time at the corresponding ambient temperature; and an ice-bridging formula fitting module configured to perform data fitting according to a corresponding relationship between the ambient temperature and the ice-bridging time corresponding thereto, and determine an ice-bridging time formula, so as to determine the corresponding ice-bridging time based on the ambient temperature as the minimum ice-bridging time.

On the basis of any example of the method of the present disclosure, the deicing control module 5300 includes: a range mapping unit configured to determine a mapping value of a temperature range to which the ambient temperature belongs; and an attenuation operation unit configured to determine a deicing duration corresponding to the mapping value based on a preset demolding attenuation formula, where the demolding attenuation formula defines that the higher a temperature represented by the temperature range, the shorter the deicing duration determined based on the mapping value of the temperature range.

On the basis of any example of the present disclosure, referring to FIG. 9, yet another example of the present disclosure further provides a computer device. The computer device may be used as a control unit in an ice maker. As shown in FIG. 9, a schematic diagram of an internal structure of the computer device is shown. The computer device includes a processor, a computer-readable storage medium, a memory, and a network interface which are connected via a system bus. The computer-readable storage medium of the computer device stores an operating system, a database, and computer programs encapsulating computer-readable instructions. The database may store a control information sequence, and the computer-readable instructions, when executed by a processor, may cause the processor to implement a method for controlling ice making and demolding. The processor of the computer device is configured to provide computing and control capabilities, thereby supporting the operation of the entire computer device. The memory of the computer device stores computer-readable instructions. The computer-readable instructions, when executed by a processor, cause the processor to perform the method for controlling ice making and demolding of the present disclosure. The network interface of the computer device is configured to be connected to and communicate with a terminal. Those skilled in the art can understand that the structure shown in FIG. 9 is merely a block diagram of a part of the structure related to the solutions of the present disclosure, and does not constitute a limitation on the computer device to which the solutions of the present disclosure are applied. Specifically, the computer device may include more or fewer components than those shown in the figure, or combine some components, or have different component arrangements.

In this example, the processor is configured to execute the specific functions of the respective modules and submodules thereof in FIG. 8, and the memory stores the program codes and various data required to execute the above modules or submodules. The network interface is configured to transmit data between user terminals or servers. The memory in this example stores program codes and data required to execute all modules/submodules in the apparatus for controlling ice making and demolding of the present disclosure, and the server can call the program codes and data of the server to execute the functions of all submodules.

The present disclosure further provides a storage medium storing computer-readable instructions. The computer-readable instructions, when executed by one or more processors, cause the one or more processors to perform the steps of the method for controlling ice making and demolding according to any example of the present disclosure.

The present disclosure further provides a computer program product including computer programs/instructions. The computer programs/instructions, when executed by one or more processors, cause the one or more processors to perform the steps of the method for controlling ice making and demolding according to any example of the present disclosure.

In summary, the present disclosure intelligently and adaptively determines the ice-forming duration and the deicing duration based on the ambient temperature, thereby flexibly controlling the whole ice-making process of the ice maker, such that the ice-making time and the deicing time of the ice maker are controlled without the interference of various variables, especially without the interference of the ambient temperature change of the physical space where the ice maker is located and the operating temperature of the ice maker itself, and in addition, ice cubes with complete shapes can be prepared without ice connection between the ice cubes. Therefore, the output quality of the ice maker is effectively improved, and the popularization and application of the ice maker are facilitated.

What is claimed is:

1. A method for controlling ice making and demolding, comprising:
acquiring an ambient temperature of a physical space where an ice maker is located;
determining, based on a first mapping relationship, an ice-forming duration corresponding to the ambient temperature, and controlling, according to the ice-forming duration, a heat exchange mechanism in the ice maker to make ice for an ice-making mold in the ice maker; and
determining, based on a second mapping relationship, a deicing duration corresponding to the ambient temperature, and after an ice-making process is completed, controlling, according to the deicing duration, the heat exchange mechanism in the ice maker to perform de-icing for the ice-making mold.

2. The method for controlling ice making and demolding according to claim 1, wherein acquiring the ambient temperature of the physical space where the ice maker is located comprises:
acquiring real-time temperatures collected by a plurality of discretely distributed temperature sensors;
performing deviation correction on each real-time temperature according to a compensation temperature corresponding to the real-time temperature to obtain a corrected temperature corresponding to each real-time temperature; and
fusing the respective corrected temperatures to obtain the ambient temperature of the space where the ice maker is located.

3. The method for controlling ice making and demolding according to claim 2, wherein before performing deviation correction on each real-time temperature according to the compensation temperature corresponding to the real-time temperature to obtain the corrected temperature corresponding to each real-time temperature, the method comprises:
performing multiple rounds of ice making by the ice maker, and acquiring corresponding real-time temperatures of each temperature sensor of the ice maker under different actual ambient temperatures during each round of ice making;
determining a compensation temperature between each real-time temperature and the corresponding actual ambient temperature thereof, wherein a compensation temperature corresponding to a real-time temperature measured by the temperature sensor during a first round of ice making is set as a mean value of error temperatures between the real-time temperatures and the corresponding actual ambient temperatures separately measured by the ice maker in a warm machine state and a cold machine state; and
performing data fitting according to a corresponding relationship between the real-time temperatures and the compensation temperatures to obtain a temperature compensation relationship formula corresponding to each temperature sensor, so as to determine, based on the real-time temperature collected by the temperature sensor, the compensation temperature corresponding to the real-time temperature.

4. The method for controlling ice making and demolding according to claim 2, wherein fusing the respective corrected temperatures to obtain the ambient temperature of the space where the ice maker is located comprises:
calculating an arithmetic mean value of the respective corrected temperatures, and taking an obtained mean value result as the ambient temperature of the space where the ice maker is located;
or presetting weights corresponding to the respective temperature sensors, calculating, based on the weights, a weighted mean value of corrected temperatures corresponding to the respective temperature sensors, and taking an obtained weighted mean value result as the ambient temperature of the space where the ice maker is located.

5. The method for controlling ice making and demolding according to claim 1, wherein determining, based on the first mapping relationship, the ice-forming duration corresponding to the ambient temperature comprises:
determining a stroke ratio between an offset stroke of the ambient temperature relative to a temperature stroke defined by a temperature range to which the ambient temperature belongs and the temperature stroke;
determining a duration difference between ideal ice-forming durations respectively corresponding to two temperature end values of the temperature range, and multiplying the duration difference by the stroke ratio to obtain an ice-forming duration increment;
superposing an ideal ice-forming duration corresponding to a minimum temperature end value of the two temperature end values with the ice-forming duration increment to obtain a trial ice-forming duration; and
determining an ice-forming duration corresponding to the ice-making mold based on the trial ice-forming duration.

6. The method for controlling ice making and demolding according to claim 5, wherein determining the stroke ratio between the offset stroke of the ambient temperature relative to the temperature stroke defined by the temperature range to which the ambient temperature belongs and the temperature stroke comprises:
querying a target temperature range to which the ambient temperature belongs according to pre-divided temperature ranges, wherein each temperature range defines one temperature stroke;
calculating a difference between the ambient temperature and a minimum temperature end value of the target temperature range, and taking the difference as an offset stroke of the ambient temperature relative to a temperature stroke defined by the target temperature range to which the ambient temperature belongs; and
dividing the offset stroke by the temperature stroke to obtain a corresponding ratio value as the stroke ratio.

7. The method for controlling ice making and demolding according to claim 5, wherein determining the ice-forming duration corresponding to the ice-making mold based on the trial ice-forming duration comprises:
determining whether the trial ice-forming duration reaches a minimum ice-bridging time corresponding to the ambient temperature;
when the trial ice-forming duration reaches the minimum ice-bridging time, setting the trial ice-forming duration as the ice-forming duration corresponding to the ice-making mold; and
when the trial ice-forming duration does not reach the minimum ice-bridging time, setting the minimum ice-bridging time as the ice-forming duration corresponding to the ice-making mold.

8. The method for controlling ice making and demolding according to claim 7, wherein
the minimum ice-bridging time is a time length starting from a moment each ice-making round starts, continuing until ice cubes form in the ice-making mold, and further extending to a moment when some ice cubes are first connected;
or the minimum ice-bridging time is a time length starting from a moment each ice-making round starts, continuing until ice cubes form in the ice-making mold, and further extending to 1-3 seconds before a moment when some ice cubes are first connected.

9. The method for controlling ice making and demolding according to claim 7, wherein before determining the ice-forming duration corresponding to the ice-making mold based on the trial ice-forming duration, the method comprises:
collecting an elapsed time when a plurality of ice molds in the ice-making mold reach a connected frozen state in a case that the ice maker makes ice at a plurality of ambient temperatures as an ice-bridging time at the corresponding ambient temperature; and
performing data fitting according to a corresponding relationship between the ambient temperature and the ice-bridging time corresponding thereto, and determining an ice-bridging time formula, so as to determine the corresponding ice-bridging time based on the ambient temperature as the minimum ice-bridging time.

10. The method for controlling ice making and demolding according to claim 1, wherein determining, based on the second mapping relationship, the deicing duration corresponding to the ambient temperature comprises:
determining a mapping value of a temperature range to which the ambient temperature belongs; and
determining a deicing duration corresponding to the mapping value based on a preset demolding attenuation formula.

11. The method for controlling ice making and demolding according to claim 10, wherein before determining, based on the second mapping relationship, the deicing duration corresponding to the ambient temperature, the method comprises:
collecting corresponding deicing durations of the ice maker at different actual ambient temperatures, and constructing a data pair by pairing each actual ambient temperature and the corresponding deicing duration;
acquiring a plurality of temperature ranges, and mapping the temperature ranges sequentially into a form of ordered values to obtain mapping values corresponding to the respective temperature ranges;
determining, based on the actual ambient temperature, a mapping value corresponding to the temperature range to which the actual ambient temperature belongs, and replacing the corresponding actual ambient temperature in the data pair with the mapping value to obtain a data pair of the mapping value and the deicing duration for each temperature range; and
performing data fitting by using the data pairs of the mapping values and the deicing durations for the respective temperature ranges to obtain a demolding attenuation formula.

12. The method for controlling ice making and demolding according to claim 10, wherein
the demolding attenuation formula defines that the higher a temperature represented by the temperature range, the shorter the deicing duration determined based on the mapping value of the temperature range.

13. An apparatus for controlling ice making and demolding, comprising:
a temperature acquisition module, configured to acquire an ambient temperature of a physical space where an ice maker is located;
an ice-making control module, configured to determine, based on a first mapping relationship, an ice-forming duration corresponding to the ambient temperature, and control, according to the ice-forming duration, a heat exchange mechanism in the ice maker to make ice for an ice-making mold in the ice maker; and
a deicing control module, configured to determine, based on a second mapping relationship, a deicing duration corresponding to the ambient temperature, and after an ice-making process is completed, control, according to the deicing duration, the heat exchange mechanism in the ice maker to perform de-icing for the ice-making mold.

14. An ice maker, comprising a control unit, a temperature sensor, an ice-making mold, and a heat exchange mechanism, wherein the control unit is configured to perform the steps of the method for controlling ice making and demolding according to claim 1, so as to determine, based on an ambient temperature collected by the temperature sensor, an ice-forming duration and a deicing duration corresponding to ice-making and de-icing of the ice-making mold by the heat exchange mechanism.

15. A non-transitory computer-readable storage medium, storing computer programs in a form of computer-readable instructions, wherein the computer programs, when called and run by a computer, cause the computer to perform the steps of the method according to claim 1.
